(19) United States
(12) Patent Application Publication
(10) Pub. No.: US 2016/0215229 A1
(43) Pub. Date: Jul. 28, 2016

(54) FISCHER-TROPSCH DERIVED GAS OIL FRACTION

(71) Applicant: SHELL OIL COMPANY, Houston, TX (US)

(72) Inventors: Rendert Jan WIERSMA, te Castricum (NL); Johannes TURFBOER, Amsterdam (NL); Robert RIEMERSMA, Amsterdam (NL); Johannes Bernardus Wilhelmus MORSINK, Amsterdam (NL)

(73) Assignee: SHELL OIL COMPANY, Houston, TX (US)

(21) Appl. No.: 15/025,342

(22) PCT Filed: Sep. 25, 2014
(86) PCT No.: PCT/EP2014/070517

§ 371 Date: Mar. 28, 2016

(30) Foreign Application Priority Data
Sep. 30, 2013 (EP) 13186739.2

(51) Int. Cl. C10M 101/00; C09K 3/00; C10L 1/04

(52) U.S. Cl. CPC C10M 101/00; C10L 1/04; C09K 3/00; C10L 2200/0492; C10L 2290/42

(57) ABSTRACT

The present invention provides a Fischer-Tropsch derived gas oil fraction having an initial boiling point of at least 245° C. and a final boiling point of at most 275° C. In another aspect the present invention provides a functional fluid formulation comprising a Fischer-Tropsch derived gas oil fraction having an initial boiling point of at least 245° C. and a final boiling point of at most 275° C.

The present invention relates to a fractionated Fischer-Tropsch derived gas oil and a functional fluid formulation comprising the same.

Fischer-Tropsch derived gas oil fractions may be obtained by various processes. A Fischer-Tropsch derived gas oil fraction is obtained using the so-called Fischer-Tropsch process. An example of such process is disclosed in WO 02/070628.

It has now surprisingly been found that specific Fischer-Tropsch derived gas oil fraction can be advantageously used in solvent and functional fluid applications.

To this end, the present invention provides a Fischer-Tropsch gas oil having an initial boiling point of at least 245° C. and a final boiling point of at most 275° C.

An advantage of the present invention is that the Fischer-Tropsch derived gas oil fraction has surprisingly a low viscosity, low pour point while having a high flash point, which combination of properties provides advantages in solvent and functional fluid applications with low viscosity requirements.

Typically, the Fischer-Tropsch derived gas oil fraction according to the present invention has very low levels of aromatics, naphthenics and impurities.

The use of the Fischer-Tropsch derived gas oil fraction thus improves the biodegradability and offers lower toxicity in solvent and/or functional fluid applications.

The Fischer-Tropsch derived gas oil according to the present invention is derived from a Fischer-Tropsch process. Fischer-Tropsch derived gas oil is known in the art. By the term “Fischer-Tropsch derived” is meant that a gas oil, is, or is derived from, a synthesis product of a Fischer-Tropsch process. In a Fischer-Tropsch process synthesis gas is converted to a synthesis product. Synthesis gas or syngas is a mixture of hydrogen and carbon monoxide that is obtained by conversion of a hydrocarbonaceous feedstock. Suitable feedstock include natural gas, crude oil, heavy oil fractions, coal, biomass and lignite. A Fischer-Tropsch derived gas oil may also be referred to as a GTL (Gas-to-Liquids) gas oil.

Fischer-Tropsch derived gas oil are primarily iso-paraffins. Preferably, the Fischer-Tropsch derived gas oil comprises more than 70 wt. % of iso-paraffins, preferably more than 75 wt. %.

A fraction of the Fischer Tropsch gasoil is a narrower boiling range distillation cut of the Fischer Tropsch gasoil and may also be seen as a GTL derived solvents distilled from the Fischer Tropsch gasoil.

According to the present invention, the Fischer-Tropsch derived gas oil fraction has an initial boiling point of at least 245° C. and a final boiling point of at most 275° C. at atmospheric conditions. Suitably, the Fischer-Tropsch derived gas oil has an initial boiling point of at least 249° C. at atmospheric conditions. Further, the Fischer-Tropsch derived gas oil fraction preferably has an initial boiling point of at least 247° C.

The Fischer-Tropsch derived gas oil fraction preferably has a final boiling point of at most 273° C. at atmospheric conditions. Further, the Fischer-Tropsch derived gas oil fraction preferably has an final boiling point of at least 271° C. at atmospheric conditions.

By boiling points at atmospheric conditions is meant atmospheric boiling points, which boiling points are determined by ASTM D86.

Preferably, the Fischer-Tropsch derived gas oil fraction has a T10 vol. % boiling point from 242 to 260° C., more preferably from 245 to 257° C., most preferably from 248 to 254° C. and a T90 vol. % boiling point from 250 to 268° C., preferably from 253 to 265° C. and more preferably from 256 to 262° C.

T10 vol. % is the temperature corresponding to the atmospheric boiling point at which a cumulative amount of 10 volume of the product is recovered. Similarly, T90vol. % is the temperature corresponding to the atmospheric boiling point at which a cumulative amount of 90vol. % of the product is recovered. An atmospheric distillation method ASTM D86 can be used to determine the level of recovery, or alternatively a gas chromatographic method such as ASTM D2887 that has been calibrated to deliver analogous results.

The Fischer-Tropsch derived gas oil fraction comprises preferably paraffins having from 12 to 17 carbon atoms; the Fischer-Tropsch derived paraffin gas oil fraction comprises preferably at least 70 wt. %, more preferably at least 85 wt. %, more preferably at least 90 wt. %, more preferably at least 95 wt. %, and most preferably at least 98 wt. % of Fischer-Tropsch derived paraffins having 12 to 17 carbon atoms based on the total amount of Fischer-Tropsch derived paraffins, preferably based on the amount of Fischer-Tropsch derived paraffins having from 10 to 18 carbon atoms.

Further, the Fischer-Tropsch derived gas oil fraction preferably has a density at 15° C. according to ASTM D4052 from 772 kg/m³ to 778 kg/m³, more preferably from 773 kg/m³ to 777 kg/m³, and most preferably from 774 kg/m³ to 776 kg/m³.

Suitably, the kinematic viscosity at 25° C. according to ASTM D445 is from 2.9 to 3.5 cSt, preferably from 3.0 cSt to 3.4 cSt, and more preferably from 3.1 cSt to 3.3 cSt.

Preferably, the Fischer-Tropsch derived gas oil fraction has a flash point according to ASTM D93 from 105 to 115° C., more preferably from 107 to 113° C., and most preferably from 107 to 111° C.

The Fischer-Tropsch derived gas oil fraction has a smoke point according to ASTM D1322 of more than 50 mm.

Typically, the Fischer-Tropsch gas oil fraction according to the present invention comprises less than 500 ppm aromatics, preferably less than 200 ppm aromatics, less than 3 ppm sulphur, preferably less than 1 ppm sulphur, more preferably less than 0.2 ppm sulphur, less than 1 ppm nitrogen and less than 4wt. % naphthenics, preferably less than 3 wt. % and more preferably less than 2.5 wt. % naphthenics.

Further, the Fischer-Tropsch derived gas oil fraction preferably comprises less than 0.1 wt. % polycyclic aromatic hydrocarbons, more preferably less than 25 ppm polycyclic aromatic hydrocarbons and most preferably less than 1 ppm polycyclic aromatic hydrocarbons.

The amount of isoparaffins is suitably more than 70 wt % based on the total amount of paraffins having from 12 to 17 carbon atoms, preferably more than 75 wt %.

Further, the Fischer-Tropsch derived gas oil may comprise n-paraffins and cyclo-alkanes.

The preparation of the Fischer-Tropsch derived gas oil fraction having an initial boiling point of at least 245° C. and a final boiling point of at most 270° C. has been described in e.g. WO02/070628.

In a further aspect, the present invention provides a functional fluid formulation comprising a Fischer-Tropsch derived gas oil fraction according to the present invention, further containing an additive compound.

Typically, the functional fluid formulations may be used in many areas, for instances oil and gas exploration and production, construction industry, food and related industries, paper, textile and leather, and various household and consumer products. Further, the type of additives used in the functional fluid formulation according to the present invention is dependent on the type of fluid formulation. Additives for functional fluid formulations include, but are not limited to, corrosion and rheology control products, emulsifiers and wetting agents, borehole stabilizers, high pressure and anti-wear additives, de- and anti-foaming agents, pour point depressants, and antioxidants.

An advantage of the use of Fischer-Tropsch derived gas oil fraction in functional fluid formulations is that the Fischer-Tropsch derived gas oil fraction has a low viscosity, low pour point while having a high flash point. Preferably, this combination of physical characteristics of Fischer-Tropsch derived gas oil fraction is highly desirable for its use in functional fluid formulations with low viscosity requirements.

For example, in drilling fluid applications, during use, the temperature of the drilling fluid may decrease which may lead to an increase of the viscosity of the drilling fluid. The high viscosity may be harmful for the beneficial use of the drilling fluid. Therefore, the Fischer-Tropsch derived gas oil according to the present invention with a low viscosity and high flash point is highly desirable for its use in drilling fluid applications.

In another aspect, the present invention provides the use of the Fischer-Tropsch derived gas oil fraction according to the present invention as a diluent oil or base oil for solvent and/or functional fluid applications.

With the term diluent oil is meant an oil used to decrease viscosity and/or improve other properties of solvent and functional fluid formulations.

With the term base oil is meant an oil to which other oils, solvents or substances are added to produce a solvent or functional fluid formulation.

The advantages of the use of the Fischer-Tropsch derived gas oil fraction as a diluent oil or base oil for solvent and/or functional fluid formulations are the same as described above for functional fluid formulations comprising the Fischer-Tropsch derived gas oil fraction according the present invention, further containing an additive compound.

Preferred solvent and/or functional fluid applications using the Fischer-Tropsch gas oil fraction according to the present invention as diluent oil or base oil include, but is not limited to, drilling fluids, fracturing fluids, heating fuels, lamp oil, barbeque lighters, concrete demoulding, pesticide spray oils, water treatment, cleaners, polishes, car dewaxers, electric discharge machining, transformer oils, silicone mastic, two stroke motor cycle oil, metal cleaning, dry cleaning, lubricants, metal work fluid, aluminium roll oil, forming oils explosives, chlorinated paraffins, cosmetics and personal care, rust preventives, printing inks, Timber treatment, polymer processing oils, and fuel additives formulations, paint and coatings, adhesives, sealants, and air fresheners.

Typical solvent and functional fluid applications are for example described in “The Index of Solvents”, Michael Ash, Irene Ash, Gower publishing Ltd, 1996, ISBN 0-566-07884-8 and in “Handbook of Solvents”, George Wypych, Willem Andrew publishing, 2001, ISBN 0-8155-1458-1. In a further aspect, the present invention provides the use of the Fischer-Tropsch derived gas oil fraction according to the present invention for improving biodegradability and lower toxicity in solvent and/or functional fluid applications.

As described above, the Fischer-Tropsch derived gas oil fraction has preferably very low levels of aromatics, sulphur, nitrogen compounds and is preferably free from polycyclic aromatic hydrocarbons. These low levels may lead to, but are not limited to, low aquatic toxicity, low sediment organism toxicity and low terrestrial ecotoxicity of the Fischer-Tropsch derived gas oil. The molecular structure of the Fischer-Tropsch derived gas oil according to the present invention may lead to the readily biodegradability of the Fischer-Tropsch derived gas oil.

The present invention is described below with reference to the following Examples, which are not intended to limit the scope of the present invention in any way.

### EXAMPLES

### Example 1

### Preparation of a Fischer-Tropsch Derived Gas Oil Fraction Having an Initial Boiling Point of at Least 245° C. and a Final Boiling Point of at Most 270° C.

A Fischer-Tropsch product was prepared in a process similar to the process as described in Example VII of WO-A-9934917, using the catalyst of Example III of WO-A-9934917. The C₅+ fraction (liquid at ambient conditions) of the product thus obtained was continuously fed to a hydrocracking step (step (a)). The C₅+ fraction contained about 60 wt % C₃₀+ product. The ratio C₆₀+/C₃₀+ was about 0.55. In the hydrocracking step the fraction was contacted with a hydrocracking catalyst of Example 1 of EP-A-532118. The effluent of step (a) was continuously distilled under vacuum to give light products, fuels and a residue “R” boiling from 370° C. and above. The conversion of the product boiling above 370° C. into product boiling below 370° C. was between 45 and 55 wt %. The residue “R” was recycled to step (a). The conditions in the hydrocracking step (a) were: a fresh feed Weight Hourly Space Velocity (WHSV) of 0.8 kg/l.h, recycle feed WHSV of 0.4 kg/l.h, hydrogen gas rate=1000 Nl/kg, total pressure=40 bar, and a reactor temperature in the range of from 330° C. to 340° C.

The obtained fuels fraction (C5⁺-370° C.) was continuously distilled at conditions as given in Table 1 to give a gas oil fraction as the bottom product. The physical properties are given in Tables 1 to 3.

TABLE 1
Fischer-Tropsch derived gas oil fraction

| | |
|---|---|
| Yield | 10.8 |
| ASTM D2892 (% m/m) | |
| Final head temperature (° C.) | 191 |
| Atmospheric cutpoint (° C.) | 270 |
| Pressure mmHg | 90 |
| Reflux ratio (sec:sec) | 20:4 |
| Bottom temperature (° C.) | 227 |

TABLE 2
Fischer-Tropsch derived gas oil fraction

| | |
|---|---|
| Kinematic viscosity at | 3.177 |
| 25° C. | |
| According to ASTM D445 | |
| [mm²/s] | |
| Kinematic viscosity at | 2.347 |
| 40° C. | |
| According to ASTM D445 | |
| [mm²/s] | |
| content of aromatics | 57 |
| According to SMS 2728 | |
| [mg/kg] | |
| content of n-paraffins | 23.57 |
| according to GCxGC - | |
| internal testing | |
| methodology | |
| [% m/m] | |
| content of isoparaffins | 74.29 |
| according to GCxGC - | |
| internal testing | |
| methodology | |
| [% m/m] | |
| Density at 15° C. | 775 |
| according ASTM D4052 | |
| [kg/m³] | |
| Flash point according to | 109.5 |
| ASTM D93 | |
| [° C.] | |
| Visual Appearance | Clear and bright |

TABLE 3
Fischer-Tropsch derived gas oil comprising paraffins
having 9 to 25 carbon atoms

| BP according to ASTM D86 | Wt. % according to ASTM D86 |
|---|---|
| [° C.] | recovered at or boils above |
| 249 | IBP |
| 250.5 | 5 |
| 251.5 | 10 |
| 254.5 | 50 |
| 260 | 90 |
| 262 | 95 |
| 268.5 | FBP |

### Example 2

### Use of Fischer-Tropsch Derived Gas Oil as a Diluent Oil/Base Oil For Solvent and/or Functional Fluid Applications

The properties of the Fischer-Tropsch derived gas oil as given in tables 1 to 3 are the critical properties for the advantage use of the Fischer-Trospch derived gas oil in drilling fluids, fracturing fluids, heating fuels, lamp oil, barbeque lighters, concrete demoulding, pesticide spray oils, water treatment, cleaners, polishes, car dewaxers, electric discharge machining, transformer oils, silicone mastic, two stroke motor cycle oil, metal cleaning, dry cleaning, lubricants, metal work fluid, aluminium roll oil, forming oils explosives, cosmetics and personal care, rust preventives chlorinated paraffins, printing inks, Timber treatment, polymer processing oils, and fuel additives formulations, paint and coatings, adhesives, sealants, and air fresheners.

### Discussion

The results in tables 1 to 3 show that a Fischer-Tropsch derived gas oil fraction with a low viscosity and high flash point was obtained.

This indicates that the Fischer-Tropsch derived gas oil fraction is desirable for its use in solvent and functional fluid formulations with low viscosity requirements.

1. Fischer-Tropsch derived gas oil fraction having an initial boiling point of at least 245° C. and a final boiling point of at most 275° C.

2. Fischer-Tropsch derived gas oil fraction according to claim 1, having an initial boiling point of at least 249° C.

3. Fischer-Tropsch derived gas oil fraction according to claim 1, having a final boiling point of between 271° C. and 273° C.

4. Fischer-Tropsch derived gas oil fraction according to claim 1, having a 10 vol. % boiling point from 242 to 260° C. and a T90 vol. % boiling point from 250 to 268° C.

5. Fischer-Tropsch derived gas oil fraction according to claim 1, having a density at 15° C. according to ASTM D4052 from 772 to 778 kg/m³.

6. Fischer-Tropsch derived gas oil fraction according to claim 1, having a kinematic viscosity at 25° C. according to ASTM D445 from 2.9 to 3.5 cSt.

7. Fischer-Tropsch derived gas oil fraction according to claim 1, having a flash point according to ASTM D93 from 105 to 115° C.

8. Fischer-Tropsch derived gas oil fraction according to claim 1. having a smoke point according to ASTM D1322 of more than 50 mm.

9. Functional fluid formulation comprising a Fischer-Tropsch derived gas oil fraction according to claim 1, further comprising an additive compound.

10. A diluent or base oil for solvent and/or functional fluid formulations, said oil comprising a Fischer-Tropsch derived gas oil fraction as defined according to claim 1.

11. (canceled)
